(19) United States
(12) Patent Application Publication
(10) Pub. No.: US 2010/0277488 A1
(43) Pub. Date: Nov. 4, 2010

(54) Deferred Material Rasterization

(76) Inventors: Kevin Myers, Santa Clara, CA (US); Antony Arciuolo, Santa Clara, CA (US); Ian Lewis, Santa Clara, CA (US)

Correspondence Address: TROP, PRUNER & HU, P.C., 1616 S. VOSS RD., SUITE 750, HOUSTON, TX, 77057-2631, US

(21) Appl. No.: 12/433,012

(22) Filed: Apr. 30, 2009

(51) Int. Cl. G09G 5/00

(52) U.S. Cl. 345/581

(57) ABSTRACT

A rasterizer may use only triangle position information. In this way, it is not necessary to rasterize objects that end up being culled in screen space.

### BACKGROUND

This relates generally to graphics processing and, particularly, to three-dimensional rendering.

Graphics processing involves synthesizing an image from a description of a scene. It may be used in connection with medical imaging, video games, and animations, to mention a few examples. A scene contains the geometric primitives to be viewed, as well as description of the lighting, reflections, and the viewer's position and orientation.

Rasterization involves determining which visible screen space triangles overlap certain display pixels. Pixels may be rasterized in parallel. Rasterization may also involve interpolating barycentric coordinates across a triangle face.

### BRIEF DESCRIPTION OF THE DRAWINGS

FIG. 1 is a depiction of a graphics pipeline in accordance with one embodiment of the present invention;

FIG. 2 is a flow chart in accordance with one embodiment of the present invention; and

FIG. 3 is a flow chart for a pixel shader shown in FIG. 1 according to one embodiment.

### DETAILED DESCRIPTION

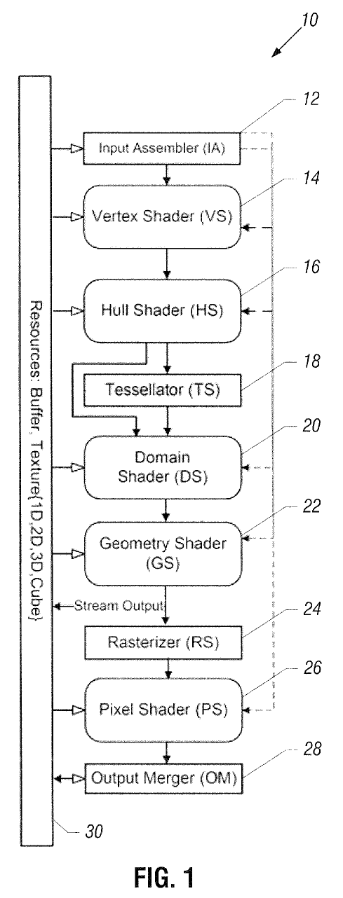

Referring to FIG. 1, a graphics pipeline 10 may include a plurality of stages. It may be implemented in a graphics processor or as a standalone, dedicated, integrated circuit, in software, through software implemented general purpose processors or by combinations of software and hardware.

The input assembler 12 reads vertices out of the memories in fixed function operations, forming geometry, and creating pipeline work items. Auto generated identifiers enable identifier-specific processing, as indicated by the dotted line on the right side in FIG. 1. Vertex identifiers and instance identifiers are available from the vertex shader 14 onward. Primitive identifiers are available from the hull shader 16 onward. The control point identifiers are available only in the hull shader 16.

The vertex shader 14 may be perform operations such as transformation, skinning, or lighting. It may input one vertex and output one vertex. In the control point phase, invoked per output control point and each identified by a control point identifier, the vertex shader has the ability to read all the input control points for a patch independent from output number. The hull shader 16 outputs the control point per invocation. The aggregate output is a shared input to the next hull shader phase into the domain shader 20. Patch constant phases may be invoked once per patch with shared read input of all input and output control points. The hull shader 16 may output edge tessellation factors and other patch constant data.

The tessellator 18 may be implemented in hardware or software. The tessellator may input, from the hull shader, numbers to find out how much to tessellate. It generates primitives, such as triangles or quads, and topologies, such as points, lines, or triangles. The tessellator inputs one domain location per shaded read only input of all hull shader outputs for the patch in one embodiment. It may output one vertex.

The geometry shader 22 may input one primitive and output up to four streams, each independently receiving zero or more primitives. A stream arising at the output of the geometry shader can provide primitives to the rasterizer 24, while up to four streams can be concatenated to buffers 30. Clipping, perspective dividing, viewpoints, and scissor selection implementation in primitive setup may be implemented by the rasterizer 24.

The pixel shader 26 inputs one pixel and outputs one pixel at the same position or no pixel. The output merger 28 provides fixed function target rendering, blending, depth, and stencil operations.

In accordance with one embodiment, the rasterizer 24 may avoid wasted interpolation and pixel shading caused by the occlusion of objects in the ultimate visible screen space depiction. The rasterizer 24 determines a transformed triangle's visible screen space position and compiles barycentric coordinates.

A typical rasterization pipeline takes object local space geometry and runs a vertex shader to determine screen space triangles. This basically involves transforming from object space coordinates to screen space coordinates. Wasted cycles arise from causing the rasterizer to interpolate unneeded attributes of occluded triangles. However, normally at initial stages of rasterization, the occluded triangles are not yet identified. Additional wasted cycles are the result of shading pixels that will be discarded later when rasterizing a triangle closer to the camera.

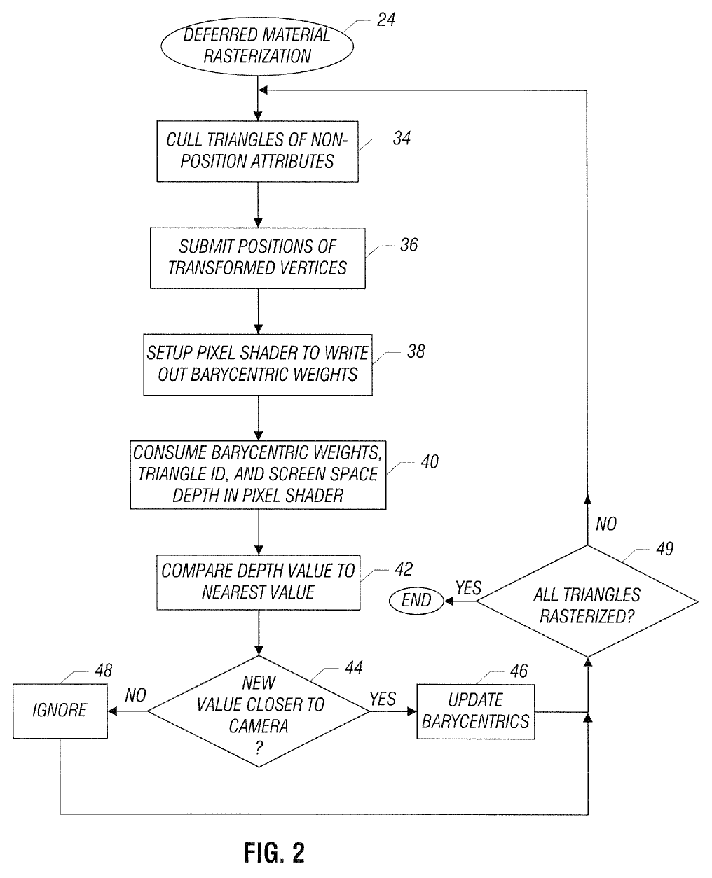

Only the positions of triangles may be submitted to the rasterizer, according to some embodiments. Referring to FIG. 2, the rasterizer 24 may implement the sequence depicted. The sequence may be implemented in software, using instructions stored on a computer readable medium or hardware.

In one embodiment, the triangles may be pre-processed so that they only contain positions, as indicated at block 34. Since positions are all that is needed, at this point, to figure out which triangles are in the camera's screen space view, only the position information is used. All other attributes may be handled later. The positions may be submitted in object space (block 36) using the rasterizer's vertex shading to move the vertices to post-projected screen space. Alternatively, transformed vertices may be submitted, relying on the rasterizer to do the perspective dividing and interpolation.

The pixel shader then directly writes out the barycentric weights (block 38). Barycentric weights indicate position relative to the corners of a triangle. In the case where the rasterizer cannot directly write out the barycentric weights, the barycentric weights may be set up in the geometry shader 22 and passed along directly to the pixel shader 26 (block 40). The pixel shader 26 then interpolates, using the barycentric weights, a triangle identifier, and a visible screen space depth. (As used herein, “depth” refers to the distance from the viewer.) In addition, an object identifier is stored per pixel.

The pixel shader then looks at the depth value, compares it to the nearest value (block 42) and, if the new value is closer to the camera (diamond 44), updates the barycentric coordinates that have been stored (block 46). Otherwise, the new value is ignored (block 48). If the pixel shader is unable to read and write the frame buffer, then the rasterizer's depth test may be used to get the closest fragment to the camera in one embodiment.

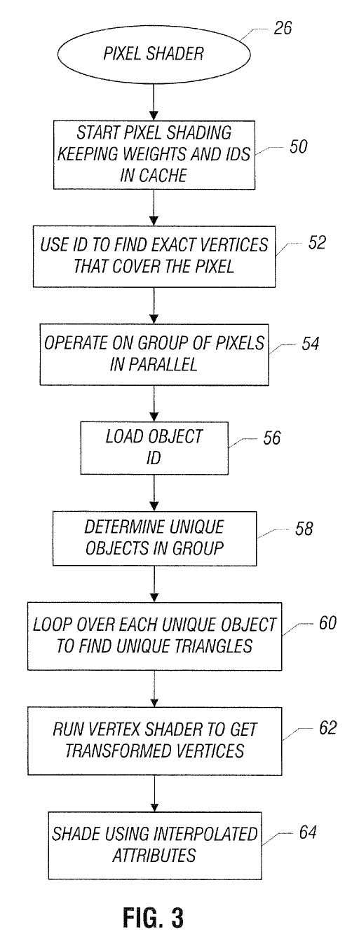

Once all of the triangles have been rasterized (diamond 49), a screen sized buffer contains barycentric weights, a triangle identifier, and an object identifier. Depending on the rasterizer, the pixel shading stage may be started (FIG. 3, block 50) either by running another pixel shader over the entire buffer or, in the case of a software rasterizer that works on chunks of the frame buffer, the threads that were used for rasterizing may be switched to pixel shading, keeping the weights and identifiers in a cache.

Actual pixel shading may be done using single instruction multiple data (SIMD) operations, such as streaming SIMD extensions (SSE). Doing pixel shading in this manner enables sharing memory and computations between pixels. The rasterizer need not compute all the attributes for shading, such as the texcoords, colors, or normals. Using the triangle identifier, the exact vertices may be found that cover the pixel (block 52). A group or tile of pixels may then be operated on in parallel, for example, using SIMD operations (block 54). The object identifier is loaded into a vector register (block 56) and vector comparison operations may be used to quickly determine all unique objects in the tile (block 58).

Looping over each unique object, the same operations may be done for unique triangles using the triangle identifier (block 60).

Finally, in an inner loop, a unique triangle and its attributes are developed. At this point, the vertex shader is used to compute the transformed vertices and to store the results in a per-thread or per-core local cache (block 62). This may avoid shading vertices more than once per thread or core.

Once the vertices have been transformed, interpolation may be done using the barycentric weights loaded into wide SIMD registers or interpolation may be differed until later, in the pixel shader, when the actual need for an attribute is known. In one embodiment, 16 pixels can be processed at a time using one pixel shader for all materials. The pixel shader may include branches and conditionals where different data is loaded, for example, for particular materials.

As an example, consider alpha tested geometry. A texcoord is interpolated right away to do the actual text or lookup to get the alpha, but there is no need to interpolate the normal until later. The vertex shader may be done earlier than needed to make the best use of the vertex cache.

Finally, the pixels are shaded using the interpolated attributes (block 64). Again, pixel shading may be done using wide SIMD instructions. Because attributes are only interpolated when they are needed, most of the context may be maintained in a cache. In general, the same pixel shader may be used for all pixels. This may be called an “Uber shader” because it is general enough to be used for all materials in the scene. This keeps the scheduling and texture latency, hiding fairly trivial because the exact layout of code and memory usage is known. To hide high latency memory accesses, C++ switch style co-routines may be used.

Because only barycentrics are stored, in some embodiments, with a couple of identifiers, several layers may be readily collected, enabling transparency to be done using order independent transparency (OIT), for example, using a k-buffer to achieve order independent transparency by storing multiple overlapping samples up to a maximum of k samples or, ideally, an anti-aliased, area-average accumulation buffer, or A-buffer, sorting the fragments in place.

In some embodiments, a highly optimized and flexible method for pixel shading uses a fixed function rasterizer to set up barycentric coordinates. The method may do everything in a single pass without wasting cycles and bandwidth computing unneeded values. There need be no special requirements, other than a rasterizer that can write out the barycentric coordinates and triangle identifiers.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
rasterizing using only triangle position information; and
transforming data for visual display.

2. The method of claim 1 including removing attributes from a triangle other than position information.

3. The method of claim 1 including submitting position information to a rasterizer in object space.

4. The method of claim 1 including submitting position information to a rasterizer in screen space.

5. The method of claim 1 including interpolating using barycentric weights and a triangle identifier.

6. The method of claim 5 including interpolating using a depth value.

7. The method of claim 6 including comparing a depth value of a first triangle to determine if there is a second triangle closer to a camera than said first triangle.

8. The method of claim 1 including using wide single instruction multiple data operations for pixel shading.

9. The method of claim 8 including shading a group of pixels in parallel, using the same pixel shader.

10. The method of claim 9 including using the triangle identifier to access attributes of the triangle other than its position.

11. An apparatus comprising:
a rasterizer to use only triangle position information; and
a pixel shader coupled to said rasterizer.

12. The apparatus of claim 11, said rasterizer to remove attributes from a triangle other than position information.

13. The apparatus of claim 11, said rasterizer to receive position information in object space.

14. The apparatus of claim 11, said rasterizer to receive position information in screen space.

15. The apparatus of claim 11, said rasterizer to interpolate using barycentric weights and a triangle identifier.

16. The apparatus of claim 15, said rasterizer to interpolate using a depth value.

17. The apparatus of claim 16, said rasterizer to compare a depth value of a first triangle to determine if there is a second triangle closer to a camera than said first triangle.

18. The apparatus of claim 11, said apparatus to use wide, single instruction multiple data operations in said pixel shader.

19. The apparatus of claim 18, said pixel shader to shade a group of pixels in parallel.

20. The apparatus of claim 19, said rasterizer to use the triangle identifier to access attributes of a triangle other than its position.
